(19) United States
(12) Patent Application Publication
(10) Pub. No.: US 2005/0116830 A1
(43) Pub. Date: Jun. 2, 2005

(54) Lifeline online smoke alarm

(76) Inventor: Brian David Wallenstein, Mount Shasta, CA (US)

Correspondence Address: BRIAN WALLENSTEIN, 2920 PINE GROVE DR., MOUNT SHASTA, CA, 96067, US

(21) Appl. No.: 10/726,468

(22) Filed: Dec. 2, 2003

(51) Int. Cl. G08B 17/10

(52) U.S. Cl. 340/628; 340/531; 340/500

(57) ABSTRACT

What is new is the union of the voice modem, with the smoke alarm, the marriage of the usb port and or the 802.11b wireless transmitter/receiver that automates the function of the smoke alarm making it a quick and efficient relay to respond electronically to home or business fires with precision, accuracy, contacting the appropriate Emergency Agencies to suppress the fire. Eliminating the human panic factor in contacting the appropriate agency, the interrupt free operation will contact the 911 before many are even aware there is a fire saving lives and property damage if no one is home, saving not only the consumer but the insurance companies and the government billions yearly, with prevention. With the use of a PC with a voice modem, a USB cable and one alarm and simple binary program on CD-rom that dials 911, audibly dictates through the voice chip the occupants, name, location (address) phone number, medical info, how many rooms, how many members, pets, a home, its occupants, and property can easily be protected. The wireless model requires an inexpensive wireless switch available at any radio Shack, Circuit City, or wholesale outlet or can be offered tandem with the wireless model. It also comes with appropriate software drivers and simple program. All are plug and play compliant, with microchips that are recognizable to Windows, Linux, OS Jaguar, etc.

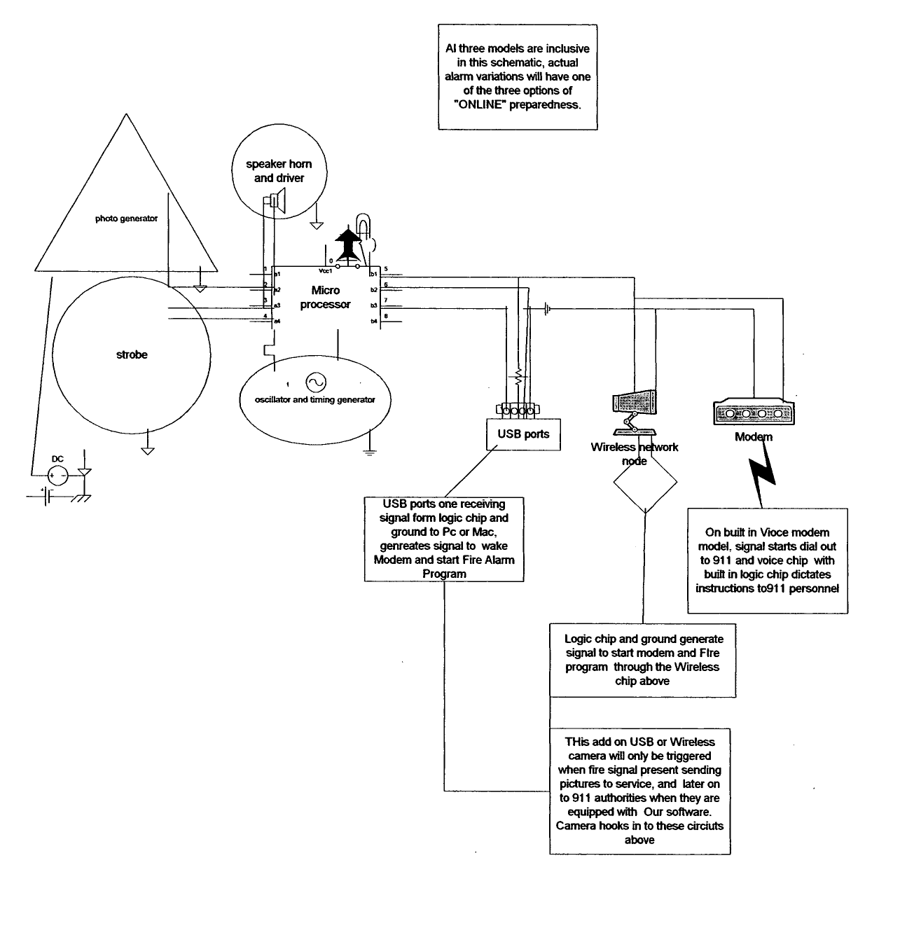

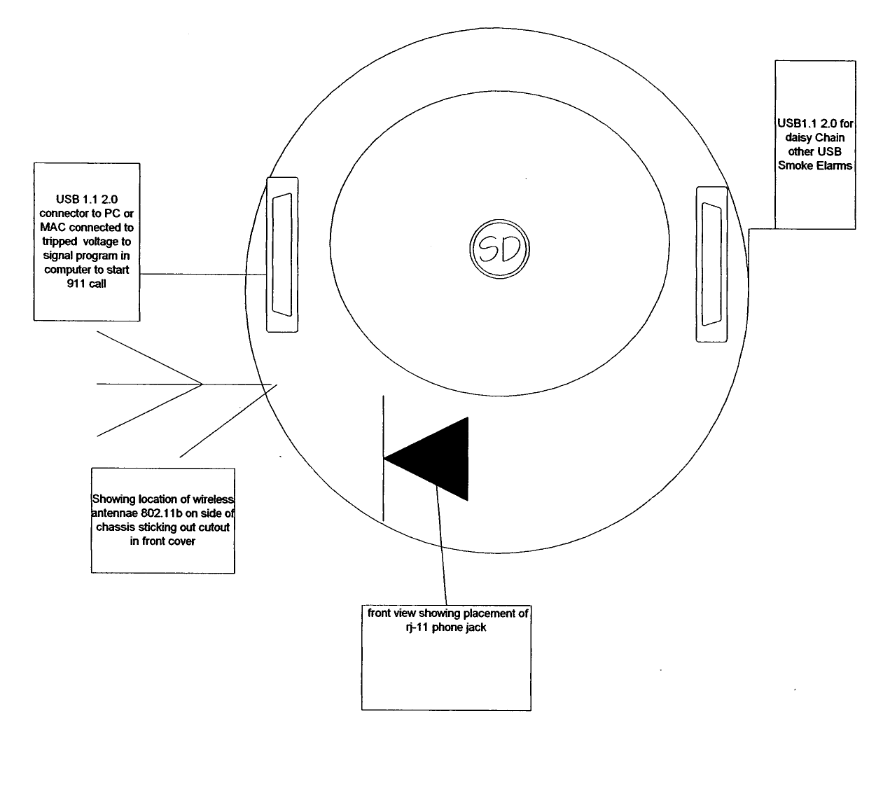

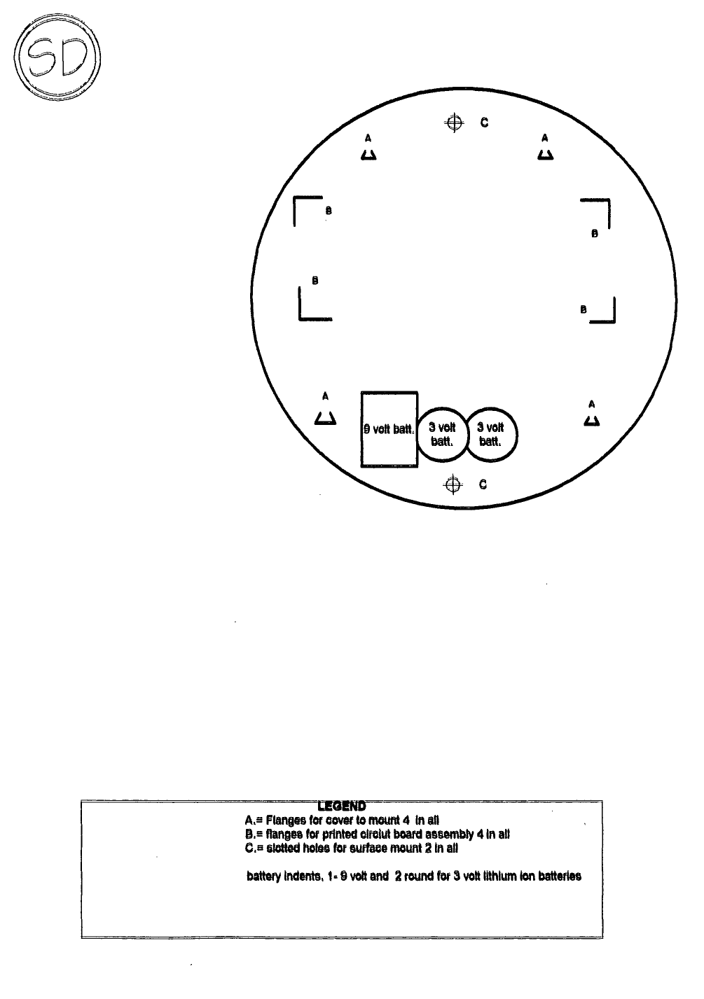

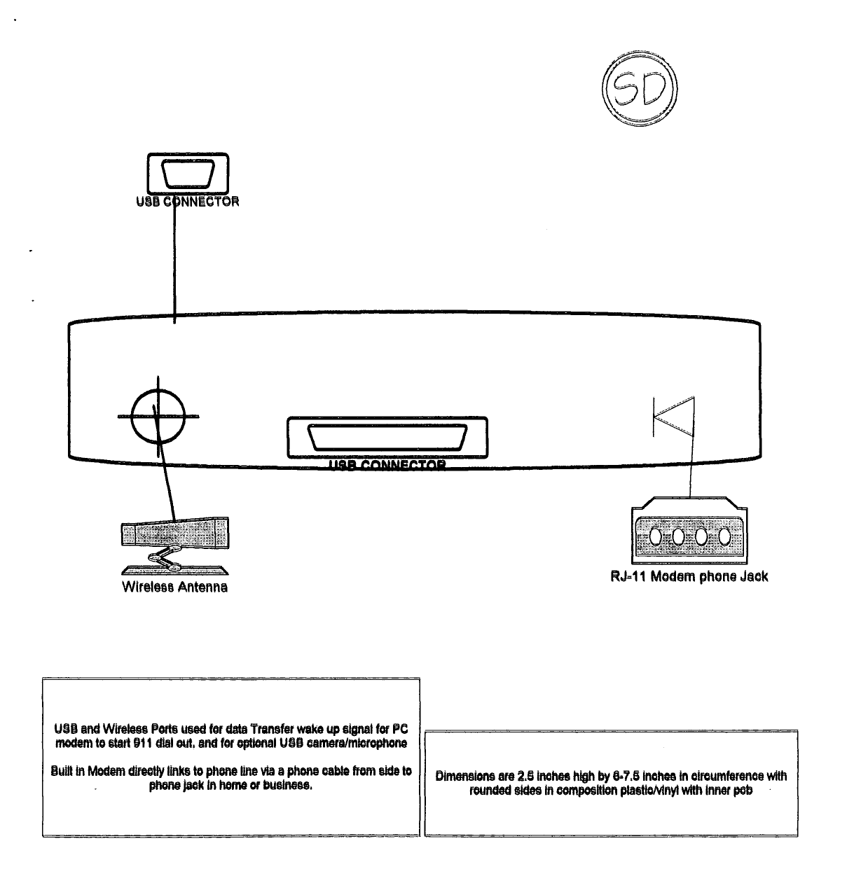

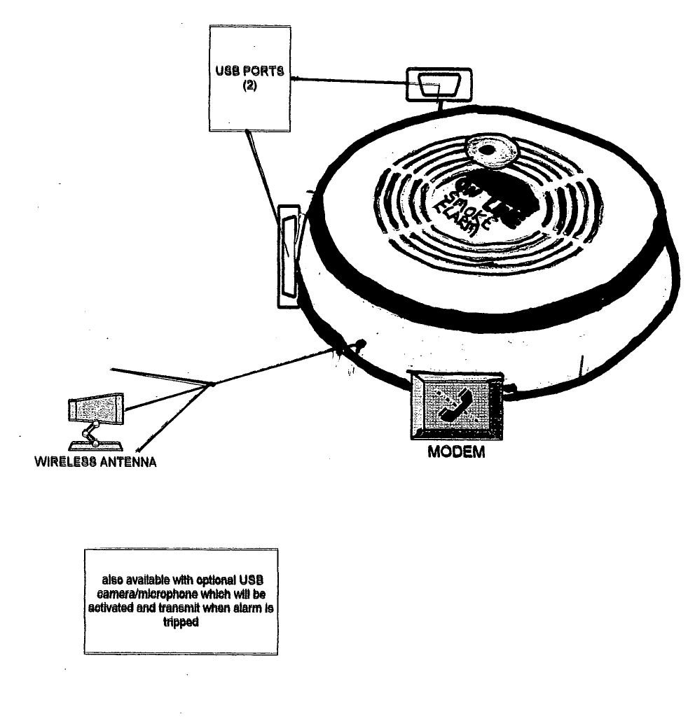

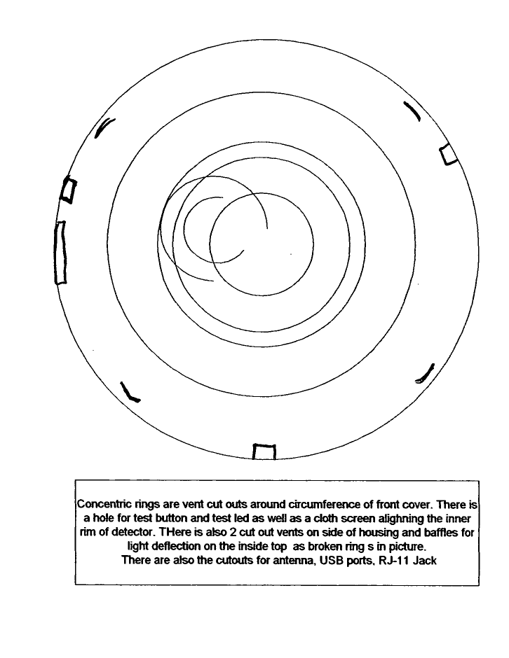

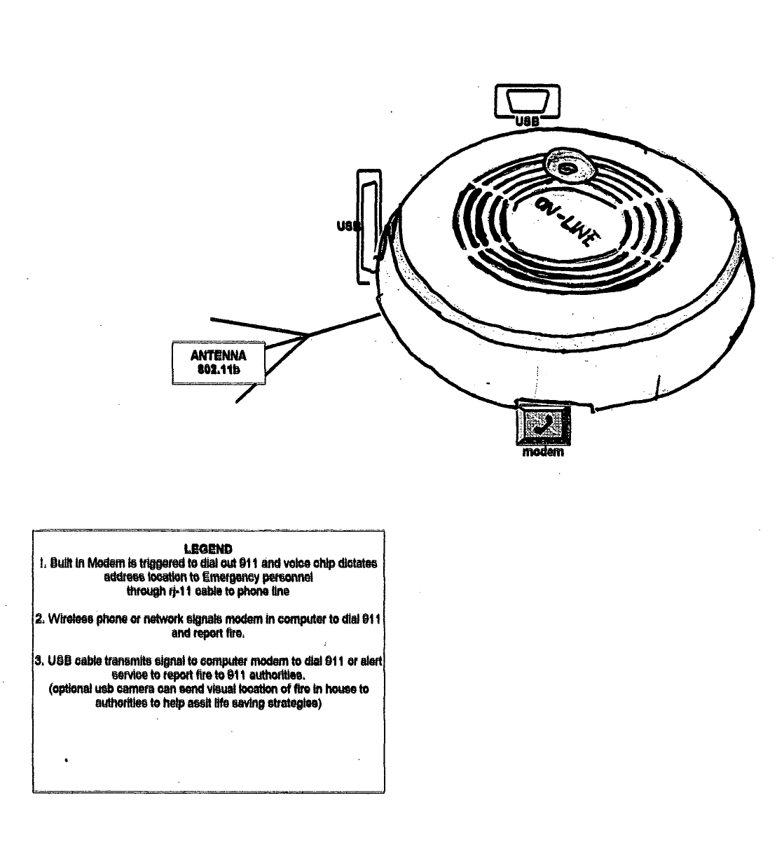

### BACKGROUND

Both Home and business smoke alarms have saved a lot of lives. With populations growing the incidence of fires are growing and the need for some new innovation is needed in the arena of quick notification and response, louder alerts and faster recoveries. MY smoke alarm departs from he crowd with louder decibels, instant connection to 911 through the use of both computer connectivity and voice modem connectivity technology.

My home or small business smoke alarms become online through a computer by use of the USB cables, or the use of the wireless 802.11 b technology and the use of a built in voice modem to employ keeping the alarm status “ONLINE.” It should be noted here that the National Fire and Home Safety Council has complained about the inadequacy of the seemingly loud horn not waking up deep sleeping children and that many deaths from fire re from parents reentering the home to rescue the children. Having children of my own it has been a big concern for parents to somehow motivate their children to the seriousness of fire from a deep sleep. MY invention can put a real edge on the technology for many families giving them the edge by alerting the fire department at the first sign of fire before they even be awake and employing a much louder oscillating horn assembly. It is also in the consideration to include a mini wireless camera or a USB camera in my technology to help locate the fire for the Fire Department aiding in putting it out and knowing where the occupants are. At this point the attribute is noted and price will make it a little prohibitive and privacy issues may arise, but the operation of it only comes to view when the alarm is triggered by smoke and fire.

### SPECIFICATIONS AND DETAILED DESCRIPTION OF FUNCTIONALITY

My smoke alarm, (Lifeline ONLINE Smoke Elarm) operates similarly to the conventional light emitting and scattering smoke switch like the typical photoelectric chip supplied by Allegro Microsystems et al, with a self test switch, led, 9 volt power source and the high decibel horn generating 120, to blast when the circuit is closed by the presence of fire and smoke.

My alarm will employ similar generic smoke chips available on the wholesale market, including the logic chip that oversees the entire operation and function of the alarm as a whole from regulating voltage to oscillating amplitude of the horn and warning of the battery power.

The ONLINE Smoke Elarm differs in over ten areas and more will be evidenced in the claims section, however this Elarm employs being online either by means of a computer and a USB cable from the computer to the Smoke Alarm spiced in parallel or series to the smoke chip and power supply, or through the use of a 802.11b wireless chip transmitter/receiver onboard with the central logic chip where as the wireless transmitter automatically sends data tot he computer via a 802.11b wireless switch, station or the like that in turn relays the signal to the computer (like the above USB cable) and wakes up the voice modem which in turn with the supplied simple binary software program calls 911 automatically when smoke trips the alarm for 60 second interval and the online pay service that also calls designated neighbors to ALERT them of a FIRE at implied residence. The modem then hangs up so the 911 dispatch can call back.

The software program also through the use of the voice modem redundantly repeats the location name and phone of where detector is for Fail-safe redundancy. The functionality of the elarm is not hindered by the absence of the pay per month subscription always automatically dialing 911 and redundantly giving the name and address and phone of the source call as 911 already receives it from caller ID however in areas where it may not be, or where its functionality may be limited, it over-rides this limitation.

If there is no PC or Mac equipped in the home with USB 1.1-2.0 the free standing built in voice modem smoke elarm keeps the individual “ONLINE” by employing both the attributes of my unique design and functionality having a both the voice chip that is generic in answering machines, voice modems, toys and other common appliances. The entire Smoke Elarm is the same except it has the onboard voice modem operating at 28.8 or 56k and a programmable central logic chip that can be programmed by the owner for their location, name, phone number, and is preset to dial 911 when the smoke elarm is triggered for 60 seconds and not manually reset or in test mode.

The other attributes that are evident in the Online Smoke Elarm is the 135-200 db horn that will oscillate to shrill, to compensate for the current inadequate horns available at 120 db. (Good Morning America) Oct. 31, 2003

The other differentiation is that there are 2 two 3.0 volt lithium ion batteries to help power the modem and the 802.11b appliances, installed within the unit on the chassis. under the polymer plastic hood.

References Cited
U.S. Patents Documents

| | | |
|---|---|---|
| 6,384,724 B1 | Landais | 340/351 |
| D475,942 S | Job | d10/106 |
| 6,642,849 | Kondziolka | 340/628 |
| 6,437,698 | Byrne et al. | 340/630 |

Field of Search:

340/628-340/640, 340/588/589

### IN DEPTH DESCRIPTION OF CIRCUIT AND HOUSING

Within invention plastic polymer based outer vented and grilled cover, is a plastic backing plate with 2 slotted holes for mounting with screws (supplied) Circumference is \hat{ }6.5 to 7.5 inches by 2.5 inches tall, with a slight taper on corners on backing plate is chassis also acting as common ground for all components including pcb.

The Grilled front allows the flow of surrounding air to circulate within and without the appliance. The smoke detector which is comprised of the smoke sensor, a central control unit acting as the regulator for sensor input/output, deactivating the alarm and testing it, by means of the eprom or IC or ASIC.

The standard optical photo detector, and the horn contained and soldered on the pcb within the case filtering out any extraneous light waveforms and dust that could contaminate the chamber and give false readings, by several plastic flanges around it coming off the cover itself Alarm sensitivity is a factory preset, with nominal manual adjustments on the sensor device, and in memory as base and learned values. Test values are also programmed in as sequential beeps on horn translating to voltage oscillations and binary values to the IC.

The power supply utilizing the chassis as its common ground is held to positive and negative terminals with the aid of a flexible plastic flange sticking up from the plastic base behind chassis, with a small silk, rayon or polyester fiber strap lashed through an eyelet to aid in its removal. On the circuit board on the same bus as the powered optical sensor, (smoke switch) after the switch power is on, the USB will receive voltage informing an interrupt onboard the computer to turn on the modem and dial out 911.

If the system is in soft mode off it will fully power up system, dial out and alert the 911 authorities, report the location, hook to the online service, alert them, then power off all within 3 minutes.

The same reaction will occur when the wireless transmission module is powered up and by the presence of smoke, and turn on the modem via wireless 802.11b and dial out 911, and repeat the exact same pattern as above with the USB cabled alarm.

This exact scenario will occur with the stand alone built in modem Online alarm alerting 911 with the location, name and address of fire. The 2 (two) 3.0 Li-ion batteries will be mounted tot he plastic backing plate and an individual isolated ground and positive terminal will provide power for the modem and wireless module, although it will also be on the smoke switching circuit, isolated from the voltage by means of the on/off switch being isolated to only the chassis circuit.

The entire circuit is held on to the backing/mounting plate by means of molded plastic flanges with tabs that fit over the edges of the 4 sides of the pcb.

The inside of the front cover has 2 concentric semi circles staggered to make a light bounce filter for the smoke switch, with cuts in them as well. The inside is then covered with a loose woven dust screen cutting down on particulate matter. Dusting will be a monthly maintenance suggestion.

The respective color design scheme will be of white, more white than ivory, or clear, or a combination of clear and silver clear and white clear and black. One design consideration is shaping the entire unit as an oval 8 inches by 5 inches and 2.5 inches high with the same specifications as the round unit.

### DRAWINGS

Included are 9 (nine) drawings depicting in order these aspects:

Picture 1 of 6 face of unit showing the 3 ONLINE options of USB, Wireless, and Built-in Modem driven on Printed circuit on chassis, with all options that are present on single breadboard pcb.

Picture 2 of 6 Shows the layout of the connectors on the side of front cover going within to chassis

Picture 3 of 6 shows back of unit, mounting holes, inside back of unit with flanges that hold in pcb, batteries, chassis and front cover.

Picture 4 of 6 shows side view of alarm with connectors, antennae and dimensions.

Picture 5 of 6 shows outside of front cover with holes for test button and led, Name placard, all connections with explanations.

Picture 6 of 7 shows inside of front cover with baffles, cut outs, mounting flanges and cutouts for rj-11 jack, USB ports, 802.11b antenna.

Picture 7 of 7 completed elarm with all options present also as title page

1. I claim the use of the USB, 802.11b, and the use of the PC and MAC as a means to aid in the delivery of fire alerting through the combination of these communication devices fused with the fire/smoke alarm triggering the USB port, voice modem that informs 911 personnel to location, name address, other pertinent data through the simple wake on voice modem software, and the standalone all in one voice modem smoke alarm that plugs into your existing phone line that automatically calls 911 when smoke and fire are present in the allowable tolerances, with the auto dialing to 911 with programmable name, address, phone number and possibly other pertinent information such as medical conditions present, number of alarms, rooms in home and square footage, and pertinent information that would aid in fore prevention and fire suppression.
I also claim the unique online pay service that can aid in the evacuation of occupants of home by means of informing neighbors, redundantly call fire authorities,
I also claim the much louder 200 db horn for greater broadcasting and alerting to help keep children awake.
The use of a USB and or a wireless 802.11b camera is also a consideration in the design of a premium model that is only activated when smoke is present helping the online service and Fire Dept. personnel locate the fire, and children to rescue them quicker and possibly save more lives.
The call back from the 911 personnel will also greatly help potential fire victims flee from their burning home by adding another interruption to deep sleep.
